(19) United States
(12) Patent Application Publication
(10) Pub. No.: US 2007/0059211 A1
(43) Pub. Date: Mar. 15, 2007

(54) TNT sensor containing molecularly imprinted sol gel-derived films

(75) Inventor: Paul L. Edmiston, Wooster, OH (US)

Correspondence Address: NIXON PEABODY LLP - PATENT GROUP, CLINTON SQUARE, P.O. BOX 31051, ROCHESTER, NY, 14603-1051, US

(73) Assignee: The College of Wooster, Wooster, OH (US)

(21) Appl. No.: 11/374,549

(22) Filed: Mar. 13, 2006

Related U.S. Application Data
(60) Provisional application No. 60/660,990, filed on Mar. 11, 2005.

(51) Int. Cl. G01N 21/00

(52) U.S. Cl. 422/82.11

(57) ABSTRACT

The invention relates to a chemically-sensitive film for use in a detector for TNT, where the chemically sensitive film includes a porous, polymeric structure and a plurality of basic functional groups integral with the porous, polymeric structure, and the basic functional groups are selectively reactive with TNT. Waveguides coated with these films can be used in sensing devices that are capable of selectively detecting TNT in a sample. Methods of making the films, waveguides, and sensors are disclosed.

This application claims the priority benefit of U.S. Provisional Patent Application Ser. No. 60/660,990, filed Mar. 11, 2005, which is hereby incorporated by reference in its entirety.

This invention was made, at least in part, with funding received from the National Science Foundation under grant 0238808. The U.S. government may retain certain rights in this invention.

### FIELD OF THE INVENTION

The present invention relates generally to molecularly imprinted sol-gel derived films and their use in an optical sensor device that can selectively detect a chemical agent, such as 2,4,6-trinitrotoluene (TNT).

### BACKGROUND OF THE INVENTION

With increased security threats at ports of entry, civic events, and at military installations, there is a significant need for swift and accurate sample analysis for the detection of explosive agents. The use and misuse of certain chemical agents (e.g., pesticides, industrial solvents, explosives, and toxic gases used as weapons) necessitates techniques that have the robustness, selectivity, and sensitivity of state-of-the art instrumentation, but are inexpensive and portable. At present, it is believed that no commercial sensor satisfies these criteria for TNT detection.

Ion Mobility Spectroscopy (“IMS”) sensors perform detection of all nitroaromatic compounds by creating chemical spectra for compounds of interest. Because this type of system does not discriminate one nitroaromatic compound from another, IMS is not selective and, therefore, is subject to false positive responses (relative to presence of TNT).

Mass sensitive sensors such as quartz crystal microbalance and surface acoustic wave designs are affected by any molecule that non-specifically binds to the surface of the sensing film. Because these sensors are also subject to non-selective binding, they are likewise susceptible to false positive responses.

It would be desirable, therefore, to develop a chemical sensor that satisfies these above-mentioned criteria. The present invention is directed to overcoming these and other deficiencies in the art.

### SUMMARY OF THE INVENTION

A first aspect of the present invention relates to a chemically-sensitive film for use in a detector for TNT. The chemically sensitive film contains a porous, polymeric structure and a plurality of basic functional groups integral with the porous, polymeric structure, the basic functional groups being selectively reactive with TNT.

A second aspect of the present invention relates to a planar optical waveguide that has a surface, and a film according to the first aspect of the present invention applied to the surface of the planar optical waveguide.

A third aspect of the present invention relates to a system for detecting TNT that includes a planar optical waveguide according to the second aspect of the present invention, a light source that couples light into the planar optical waveguide, and a detector that senses emission of light from the planar optical waveguide, wherein the emitted light identifies presence of TNT. The emitted light preferably identifies presence of TNT via a decrease in light outcoupled from the waveguide at a wavelength corresponding to TNT anion absorption. The magnitude of the decrease in outcoupled light corresponds to the quantity of TNT anion absorbed by the sensing film and, hence, the quantity/concentration present in the sample.

A fourth aspect of the present invention relates to a method for detecting TNT in a sample that includes the steps of: introducing a sample potentially containing TNT to a system according to the third aspect of the present invention, and detecting a decrease in light outcoupled from the waveguide at a wavelength corresponding to TNT anion absorption, wherein the decrease in light outcoupled from the waveguide indicates presence of the TNT anion in the introduced sample.

A fifth aspect of the present invention relates to a method of making a chemically-sensitive film according to the first aspect of the present invention. This method includes the steps of forming a sol-gel solution in the presence of an alkoxysilane compound having one or more sidechains that each contain a basic group reversibly bound to a moiety that is structurally similar to TNT; preparing from the sol-gel solution a porous, polymeric structure in the form of a film; and removing the moiety from the film, thereby forming the plurality of basic functional groups integral with the porous, polymeric structure.

A sixth aspect of the present invention relates to a trialkoxysilane according to formula (I) 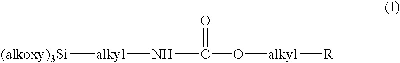
wherein each alkyl group is independently a C1 to C10 alkyl, each alkoxy group comprises a C1 to C4 alkyl, and R comprises a nitroaromatic ring.

A seventh aspect of the present invention relates to a sol-gel formed upon reaction of a (poly)alkoxysilane with a trialkoxysilane according to the sixth aspect of the present invention. A sol-gel in accordance with this aspect of the present invention can be used to prepare the films in accordance with the first aspect of the present invention.

The present invention provides a durable and robust optical sensor for TNT. The sensor described herein can be used to screen for TNT based explosives in baggage, containers, or clothing. Screening can be done in locations such as airports, border checkpoints, ports, or other security checkpoints. The sensor may also be useful in detecting landmines if enough TNT vapor is emitted from the buried weapon.

### BRIEF DESCRIPTION OF THE DRAWINGS

FIG. 1 is a schematic of a TNT chemical sensor showing the glass support, high index waveguide layer, and sensing layer. A laser is prism coupled into the waveguide layer. The propagating beam interacts with the sensing layer upon each internal reflection. An evanescent wave is generated at each reflection and decays exponentially into the lower index medium. Light is absorbed by chromophores within the evanescent region at each reflection as the beam propagates down the waveguide.

FIG. 2 illustrates a TNT detection system in accordance with the present invention.

FIG. 3 illustrates synthesis of the mDNB template used to form sol-gel sensing layers for TNT.

FIG. 4 illustrates schematically the steps used in the formation of a TNT sensor film. Step A represents preparing or providing the mDNB template used to imprint for TNT. Step B illustrates co-polymerization of mDNB with BTEB by base catalyzed hydrolysis and condensation of alkoxysilane groups, which leads to a matrix where the template is covalently bound. Films are deposited by dip-coating. In step C, the template is removed by cleaving the carbamate linkage using iodotrimethylsilane and methanol. In step D, a shape-specific pocket aids in binding TNT. The amine group can hydrogen bond with the TNT and deprotonate the methyl group to convert TNT into its anionic form (deprotonation reaction not shown).

FIG. 5 is an intensity vs. time curve for a sensor with an mDNB sensing film (top) and a control film (bottom) tested with pure acetonitrile or 100 ppm TNT solutions.

FIG. 6 is an intensity vs. time curve for a sensor with an mDNB sensing film (top) and a control film (bottom) tested with pure nitrogen or 50 ppb TNT in a 50 mL/min nitrogen gas flow stream.

FIG. 7 illustrates schematically the molecular imprinting scheme for TNT using the DIOL template. In Step A, 5-nitro-m-xylene-α,α′-diol is reacted with 3-isocyanto-propyltriethoxysilane to form the DIOL sacrificial spacer. In Step B, the DIOL template is incorporated into a BTEB sol-gel matrix. In Step C, the template is removed by treatment with iodotrimethylsilane followed by methanol. Free silanols are also eliminated in this process. In Step D, binding of TNT is facilitated by the shape of binding pocket, π-π interactions, and the amine groups left after template removal.

FIG. 8 illustrates sensor response to 4 femtomoles/s TNT. The sensing layer is composed of BTEB:pyridine-silane (90:10)-mDNB template.

FIG. 9 is an AFM image of a BTEB sol-gel sensing layer. The xy units of the plot are in μm.

FIG. 10 is an SEM image of a BTEB sol-gel sensing layer.

FIG. 11 is a graph illustrating the response at 530 nm of an integrated optical waveguide sensor based on BTEB:pyridine-silane (90:10)-mDNB template sol-gel film prepared in acetonitrile to 4×10⁻¹⁵ moles/s TNT vapor in air. The inset graph illustrates the response measured at 647 nm (wavelength where TNT ion does not absorb light).

FIG. 12 is a graph illustrating the response at 530 nm of an integrated optical waveguide sensor based on BTEB:pyridine-silane (90:10)-mDNB template sol-gel film prepared in THF to 4×10⁻¹⁵ moles/s TNT vapor in air. The inset graph illustrates the response measured at 647 nm.

### DETAILED DESCRIPTION OF THE INVENTION

The present invention relates to an optically based chemical sensor that can selectively detect the explosive 2,4,6-trinitrotoluene (TNT), novel subcomponents of the sensor, as well as methods of making the subcomponents and sensor, and methods of using the sensor selectively to detect the presence of TNT in a sample.

One aspect of the present invention relates to a chemically-sensitive film that can be used in the sensor for use selective detection of TNT.

The chemically sensitive film is a porous, polymeric structure that contains a plurality of basic functional groups integral with the porous, polymeric structure. It is the basic functional groups that are selectively reactive with TNT.

Selective binding to TNT can be achieved, for example, through the use of molecular imprinting of the film so that a plurality of binding pockets are provided within the porous, polymeric structure. Each of the binding pockets has presented therein (i.e., exposed internally of the binding pocket) one or more of the basic functional groups.

The basis of the optical sensing in the present invention is the conversion of TNT into its anionic form in the sensing film by deprotonation of the methyl group of TNT by the basic functional group found in the binding pocket. TNT anion formation has been recognized for some time (Caldin & Long, Proc. Roy. Soc. Ser. A 228:263-285 (1955), which is hereby incorporated by reference in its entirety), but the reaction has yet to be reported to be done in a sol-gel let alone for use in a sol-gel based sensor. The anionic form of TNT absorbs in the visible portion of the electromagnetic spectrum between 500-550 nm. Thus, when TNT binds to the sensing layer and is converted to the colored anionic form, it attenuates the total internally reflected beam in the waveguide by absorbing light from the evanescent wave that occurs upon each reflection. The greater the amount of TNT bound, the greater the attenuation of light. By measuring the intensity of the outcoupled beam within the 500-550 nm bandwidth, the amount of TNT can be quantified when the sensor is calibrated to known standards.

There are two major approaches to molecular imprinting: non-covalent and covalent. Non-covalent imprinting has been the most widely used strategy and relies on non-covalent interactions between functional groups on monomers and the template in order to position the monomers in a specific spatial orientation prior to polymerization. Covalent molecular imprinting leads to strong interactions due to reformation of the covalent bond between the matrix and the target. Because of the homogeneity of the binding sites and the high interaction strength between target and matrix, 80% to 90% of the sites produced by covalent imprinting are able to bind the target.

A hybrid molecular imprinting strategy is used in the present invention, combining the versatility of non-covalent imprinting with the binding site homogeneity produced by covalent methods. This hybrid strategy uses polymerizable monomers that are first covalently bound to a template molecule, i.e., a moiety that is a structural analog of TNT. Following polymerization, this moiety can be cleaved to remove the template and form the binding pocket. If appropriate chemical bonds between the spacer and the matrix are used, removal of the spacer will leave residual functional groups (e.g., the basic groups referenced above and described hereinafter) from the bond cleavage that can aid in the binding of the target by forming complementary non-covalent intermolecular interactions within the pocket.

Structural analogs of TNT are preferably nitroaromatics that contain at least one nitro group. Exemplary structural analogs of TNT include, without limitation, nitrobenzene, methylnitrobenzenes, methyldinitrobenzenes, methyltrinitrobenzene, ethylnitrobenzenes, ethyldinitrobenzenes, ethyltrinitrobenzene, dinitrobenzenes, trinitrobenzene, nitrotoluenes, dinitrotoluenes, nitroxylene, dinitroxylene, trinitroxylene, and nitrostyrene. Of these, methyldinitrobenzenes are preferred.

The polymerizable monomers can be fabricated by reacting the structural analog alcohols, e.g., methyldinitrobenzene alcohol, with a trialkoxysilane comprising a sidechain having a terminal isocyanate. The resulting polymerizable monomer includes the trialkoxysilane having a cleavable carbamate linkage with the structural analog. Cleavage of the carbamate linkage to remove the moiety containing the structural analog results in a free basic group, e.g., the primary amine.

The polymerizable monomers are trialkoxysilanes that have a structure according to formula (I) as follows: 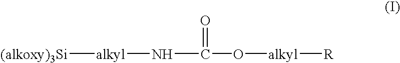
wherein R is a group containing a nitroaromatic ring, preferably those containing at least one nitro group. Exemplary R groups include the structural analogs of TNT described above. Each of the alkyl groups can individually be of any length, but preferably a C1 to C10 alkyl group, with the alkyl group being either saturated or (poly)unsaturated. Each of the alkoxy groups of the trialkoxysilyl moiety is preferably a C1 to C4 alkyl. Also encompassed are bis compounds according to formula (II) as follows: 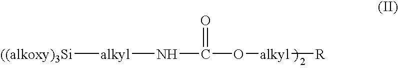
wherein each of the substituents are those defined above.

Exemplary polymerizable monomers that include a structural TNT analog are as follows:

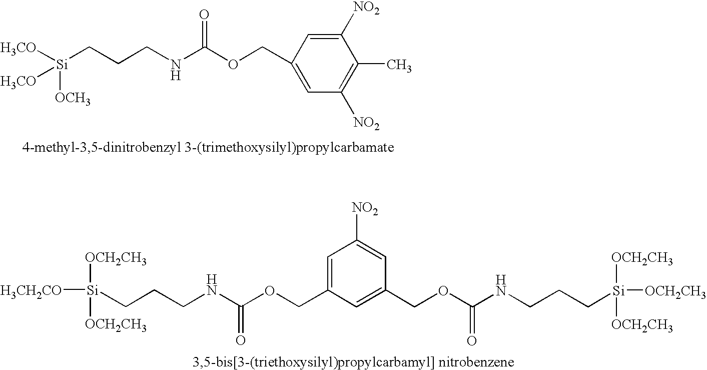

The porous, polymeric structure can be formed of any suitable materials. The properties of the polymeric structure that render it capable of use in the sensors of the present invention include: a porosity suitable to allow for diffusion of TNT, optical transparency of a film (formed of the polymeric material) to light used in the detector, an ability to adhere to a waveguide surface, and a basic functional group that can convert TNT to its anion.

Preferred polymeric structures are those that are formed from a sol-gel following removal of solvent therefrom. The sol-gel process involves the generation of inorganic networks through the formation of a colloidal suspension (sol) and gelation of the sol to form a network in a continuous liquid phase (gel). Precursors for this process are metal or metalloid elements bonded by various reactive ligands. Sol-gels are typically synthesized from alkoxysilanes which react readily with water in the presence of an acid or base catalyst. Polymerization follows the process of hydrolysis, alcohol condensation, and water condensation which results in the three dimensional porous siloxane network which constitutes the gel.

Preferred alkoxysilanes include, without limitation, tetraalkoxysilanes and trialkoxysilanes, where the alkyl component typically contains from one to four carbons. The various alkyl components can be the same or different. The alkoxysilanes most preferably contain either an aromatic bridging group or an aromatic sidechain. Exemplary (poly)alkoxysilanes that can be used include, without limitation, bis(2-(trimethoxysilyl)ethyl)benzene (referred elsewhere herein as “BTEB”), 2-(2-(trimethoxysilyl)ethyl)pyridine (referred elsewhere herein as “pyridine”), triethoxy(2,3,5,6-tetrafluoro-4-(trifluoromethyl)phenyl)silane (referred elsewhere herein as “FPTES”), bis(trimethoxysilylpropyl)amine, bis(3-trimethoxysilylpropyl)-N-methylamine, 1,4-bistriethoxysilyl)benzene, p-bis(trimethoxysilylmethyl)benzene, bis(triethoxysilyl)ethane, bis(trimethoxysilyl)ethane, phenyltrimethoxysilane, methyltrimethoxysilane, isobutyltrimethoxysilane, N-(3-triethoxysilylpropyl)4,5-dihydroimidazole, 3-trifluoroacetoxypropyltrimethoxysilane, N-(3-trimethoxysilylpropyl)pyrrole, 3-(N,N-dimethylaminopropyl)trimethoxysilane, 3-(N,N-diethylaminopropyl)trimethoxysilane, 3-cyanopropyltrimethoxysilane, 2-cyanopropyltrimethoxysilane, and combinations thereof.

Of these, BTEB, pyridine, FPTES, and combinations of BTEB:pyridine are preferred. BTEB:pyridine molar ratios from about 3:2 up to about 20:1 are preferred, with about 4:1 up to about 9:1 being most preferred.

The structures of these preferred alkoxysilanes are shown below.

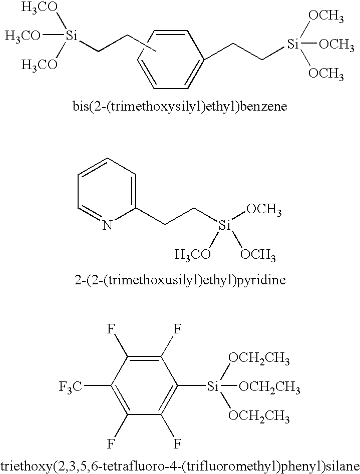

Preferred solvents for use in forming the sol-gel reaction include, without limitation, THF and acetonitrile. Water is also present in a suitable amount.

The preferred polymeric structures that are formed using alkoxysilane-derived sol-gels are characterized by a polymerized siloxane backbone with bridging aromatic groups. It is believed that the bridging aromatic provides an electron rich environment and the ability to pi-stack. Depending upon the addition of other monomeric or multimeric components, the backbone can include additional (hetero)aromatic or non-aromatic (hetero)ring substituents.

The main advantage of sol-gels is that they are chemically and mechanically durable and optically transparent. Thus, such materials can be utilized in harsh chemical environments and are amenable for use in optical sensing devices. Since sol-gels can be tailored to be porous, molecules are free to diffuse into and out of the gels. Moreover, sol-gels can easily be cast into films by simple dip or spin coating procedures.

Depending upon the conditions employed, the porosity of the polymeric structure can be controlled. Preferably, the polymeric structure is characterized by a surface area exceeding about 400 m²/g and internal pore volumes exceeding 0.3 mL/g. The polymeric structure has channels or pores that are between about 2.5 nm up to about 100 nm, more preferably between about 15 to about 80 nm. The sol-gels made in THF are almost completely microporous with pores <6 nm in size. In contrast, the sol-gels made in acetonitrile are mostly mesoporous with pore sizes between 15-80 nm.

For the sol-gels formed using a polymerizable monomer to molecularly imprint the sol-gel structure, prior to use of the sol-gel, the moiety containing the TNT analog must be first removed, i.e., to form the binding pocket and expose the basic functional group that can react with TNT to form a TNT anion. Using the preferred polymerizable monomers of the present invention that contain a carbamate linkage, the carbamate linkage can be cleaved using iodotrimethylsilane (“ITMS”) and acetonitrile under appropriate conditions. Exemplary conditions include heating to about 40 to about 70° C., preferably about 60° C., for sufficient time.

The basic functional groups can be any group that is capable of binding reversibly to TNT, thereby forming a TNT anion. Exemplary basic functional groups include, without limitation, primary and secondary amines, and N-heterocycles such as imidazoles, pyridines, quinolines, purines, and pyrimidines. Of these, the primary and secondary amines are preferred. As noted above, the basic functional groups are formed upon removing from the sol-gel polymer the moiety that is structurally similar to TNT. The polymeric structure can include only one type of basic functional group throughout (i.e., each of the binding pockets possesses only the one type) or a combination of the basic functional groups.

The chemically sensitive film can have any thickness that results in optical transparency to the wavelength of light employed in the device, and capability of reversibly binding to TNT anions. The thin film preferably has a thickness of less than about 10 μm, preferably between about 10 nm to about 5 μm, more preferably between about 50 nm to about 2 μm, most preferably about 100 nm to about 1 μm. The thickness of the thin film is preferably substantially uniform over the entire dimension of the film, although variations are tolerable as long as the optical transparency and reversible binding to TNT anions are not impacted.

Sol-gel formation is carried out using one or more of the alkoxysilanes and one or more polymerizable monomers that include the structural TNT analogs, in a suitable amount of solvent (e.g., THF or acetonitrile) in the presence of water and fluoride catalyst (e.g., TBAF). The sol-gel solution was stirred and allowed to aged prior to forming a film. The aging process can be anywhere from about 1 hour up to several days.

In the sensors of the present invention, the polymeric thin film is present as a coating applied to a planar optical waveguide. The planar optical waveguide can be formed of any suitable materials, now known or hereafter developed. Exemplary materials include, without limitation, glasses and polymers, which can be doped or undoped. The waveguide material preferably has a high index of refraction.

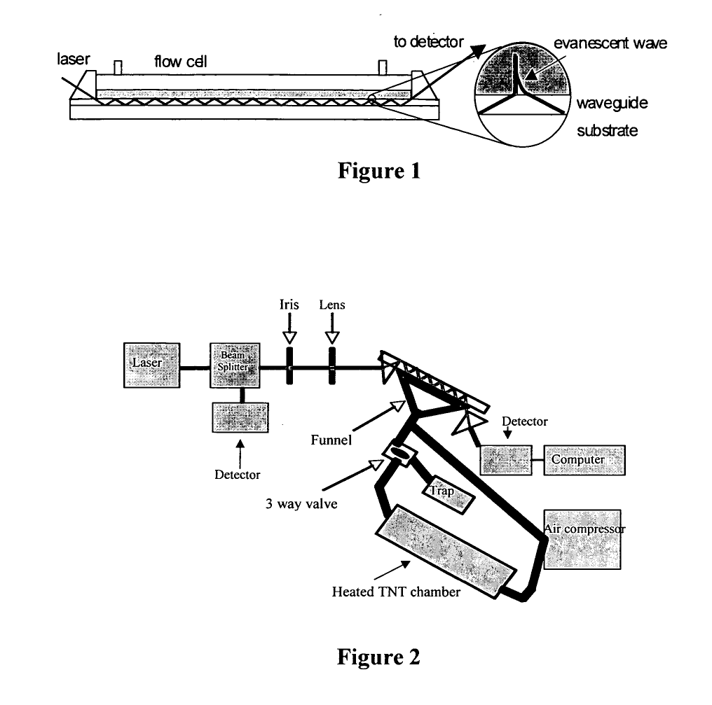

The planar optical waveguide is typically formed as a phototransmissive layer on a transparent solid substrate. Light can be sent into the waveguide through a prism or grating where it is totally internally reflected down the structure. At each reflection an evanescent wave is generated which decays exponentially into the lower index medium (FIG. 1). The depth of penetration of this electromagnetic field is on the order of the wavelength of the light and attenuation of the beam at each reflection will occur if evanescent light is absorbed by molecules in the sensing film (a process termed attenuated total reflectance, ATR). The substrate provides for internal reflectance and propagation of the signal throughout the phototransmissive layer.

The waveguides preferably have a thickness equal to or less than 1 μm, which allows a totally internally reflected beam to achieve approximately 1000 reflections per cm of beam travel. This allows for reliable absorbance measurements with most sensing films, even those having a thicknesses of less than about 500 nm.

Regardless of the waveguide construction, the polymeric thin film is formed directly on top of the waveguiding layer (i.e., on the side opposite the substrate). After aging the sol-gel (described above), the sol-gel can be diluted in THF or acetonitrile and then applied to the waveguide in a manner suitable to achieve a film on the waveguide surface having the desired thickness. Dilution can be between about 1:2 up to 1:10. Preferred application is by spin-coating or dipping a masked waveguide surface in the diluted sol-gel solution. Upon solvent evaporation, the porous sol-gel film remains on the waveguide surface.

After preparing the film, the moiety containing the structural TNT analog can be removed from the film, thereby forming the binding pockets having the exposed basic functional groups. Before removal of the moiety, the entire assembly (film-coated waveguide) can be placed in acetonitrile overnight or soxhlet extracted with acetonitrile for several hours. After this pre-treatment, the moiety can be removed as described above. The waveguides can be removed from the ITMS, and then rinsed and stored in acetonitrile until ready for use.

A system for sensing TNT includes the planar optical waveguide of the present invention, a light source that couples light into the planar optical waveguide; and a detector that senses emission of light from the planar optical waveguide. An exemplary system is shown in FIG. 2.

Any suitable components or constructions can be employed for coupling of light into and out of the planar optical waveguide, including prisms or optical gratings.

The light source can be any light source that will produce light within at least a portion of the 500-550 nm bandwidth, preferably at or near 530 nm. The light source can be white light or monochromatic, and it can produce a substantially collimated beam of light or dispersed light. Exemplary light sources include, without limitation, a light-emitting diode, a laser, an incandescent or fluorescent light source, and diode laser.

The light sensor that is used to detect the light emitted or outcoupled from the planar waveguide can be any suitable detection that is sensitive enough to detect even minute decreases in light within the 500-550 nm bandwidth, as described above. Exemplary light sensors include, without limitation, a photodiode, charge-coupled display, spectrophotometer, or phototransistor.

According to one embodiment, the sensor can further include a housing having a sample port in proximity to the sensing film and a pump or other means for delivering a sample into the housing and passing it over the film. The flow rate can be adjusted to optimize results and processing time. The pump can deliver the sample in, e.g., compressed air or nitrogen, or other suitable media. This will allow any TNT in the sample to bind to the basic functional groups within the film. In this embodiment, the housing is also intended to contain the planar optical waveguide, the light source, and the detector.

The output of the light sensor can be integrated into a processor of a computer, which also contains a display and a memory. According to one embodiment, these components can also be contained within the housing. According to another embodiment, the sensor device merely includes appropriately configured connectors or ports to allow for transmission of the output signal from the light sensor to a separate computer processor.

In use, the film will be exposed to a sample potentially containing TNT and then, after passing light through the waveguide, emitted light is detected to determine whether TNT was present in the sample. TNT detection is evident when there is a decrease in light outcoupled from the waveguide at a wavelength corresponding to TNT anion absorption. The TNT anion absorption spectra has a broad peak at 500-550 nm with maximum absorption at about 530 nm. Thus, the decrease in outcoupled light, for example when measured within the 500-550 nm band, indicates presence of the TNT anion in the introduced sample.

In addition to simple detection of presence/absence, the amount of TNT present in the sample can be quantified based upon the magnitude of the decrease in light outcoupled from waveguide. Higher absorption of light within the 500-550 nm band indicates a greater concentration of TNT anion in the sensing film, and hence a greater concentration in the sample.

The sample to which the film is exposed can be either in a condensed, liquid phase or in a vapor phase.

Based on the sensing films and systems of the present invention, the detection limits as low as about 3×10⁻¹⁴ moles/s TNT in air have been obtained. (It takes several seconds of exposure to 1×10⁻¹⁴ sample to trip a threshold change in outcoupled light intensity (2.5% change in % transmittance). Lower concentrations can be detected, but a longer exposure time is needed. The sensor is a substantially irreversible integrating device, although the TNT anion binding can be reversed in acetonitrile. Further optimization should allow even lower limits of detection.

### EXAMPLES

The following examples are provided to illustrate embodiments of the present invention but they are by no means intended to limit its scope.

### Example 1

### Synthesis of Polymerizable Methyl Dinitrobenzene (mDNB) Alkoxysilane Monomer

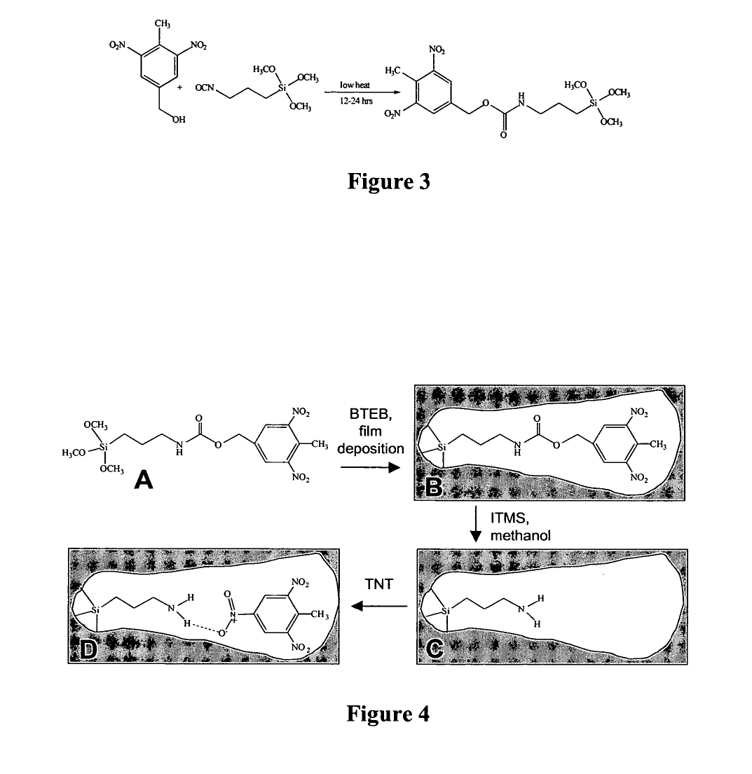

One alkoxysilane monomer that was used (in subsequent examples) to imprint sensing films contained the TNT analog mDNB. The monomer was synthesized by reacting 3-isocyanatopropyltrimethoxysilane and 4-methyl-3,5-dinitrobenzyl alcohol in a 1:1 molar ratio at 50° C. for 24 hr (FIG. 3). An IR spectrum and nuclear magnetic resonance (NMR) spectra were taken of the product to confirm completion of the reaction. FT-IR confirmed the disappearance of the O═C═N peak at 2200 cm⁻¹ and the appearance of the C═O peak at 1650 cm⁻¹. The product was also confirmed by 400 MHz ¹H NMR. The mDNB was dissolved in THF for subsequent manipulations.

The mDNB template could not be stored for long periods of time because, as indicated by IR analysis, composition changes consistent with hydrolysis and possibly partial condensation were detected (by color change). Side reactions causing dimerization of mDNB were most likely causing the observed color change. Therefore, to minimize the deprotonation of mDNB during sol-gel fabrication, the amount of H₂O added to the sol-gels was doubled (i.e., from initial experiments). While the color change still occurred, it was much diminished.

### Example 2

### Synthesis of Polymerizable 5-nitro-m-xylene diol (DIOL) Alkoxysilane Monomer

A second alkoxysilane monomer that was used (in subsequent examples) to imprint sensing films contained the TNT analog 5-nitro-m-xylene-α,α′-diol. The monomer was synthesized by reacting 5-nitro-m-xylene-α,α′-diol is reacted with 3-isocyantopropyl triethoxysilane in a 1:1 molar ratio at 50° C. for 24 hr. FT-IR confirmed the disappearance of the O═C═N peak at 2200 cm⁻¹ and the appearance of the C═O peak at 1650 cm⁻¹. The product was also confirmed by 400 MHz ¹H NMR. The DIOL was dissolved in THF for subsequent manipulations.

### Example 3

### Waveguide Fabrication

Integrated optical waveguides were fabricated as described previously (Yang et al., Anal. Chem. 66:1254-1263 (1994), which is hereby incorporated by reference in its entirety) by dip-coating a waveguide sol-gel solution onto a transparent glass substrate.

The waveguide sol-gel solution was prepared by mixing 30 mL of methyl-trimethoxysilane, 15 mL of titanium(IV) tetrabutoxide, and 60 mL of ethanol. Polymerization was catalyzed by the addition of 3 mL of silicon(IV) chloride. After aging the sol-gel solution for at least 24 hr, films were deposited by dip-coating a glass microscope slide withdrawn from the sol-gel solution along its long axis at a rate of 5-10 cm/min. The films were then annealed at 510° C.-520° C. for 15 min and cooled to room temperature before coating with the sensing film.

### Example 4

### Sensing Film Fabrication and Deposition

The sol-gel for the sensing film was prepared by co-polymerizing the template alkoxysilane monomer (mDNB or DIOL) with one or more alkoxysilanes as shown in Table 1 below.

TABLE 1
Components of the sol-gels synthesized for sensing films

| | | | | Age |
|---|---|---|---|---|
| Film | Matrix | Template | Components | Time |
| 1 | BTEB | 1% 0.068206 M | 260 μL BTEB, | 6 d |
| | | mDNB | 99 μL 0.068206 | |
| | | | M mDNB | |
| 2 | 9:1 | 10% 0.035549 M | 234 μL BTEB, | 6 d |
| | BTEB:pyridine | mDNB | 16.1 μL pyridine, | |
| | | | 1898 μL 0.035549 M | |
| | | | mDNB | |
| 3 | 9:1 | 1% 0.035549 M | 234 μL BTEB, | 6 d |
| | BTEB:pyridine | mDNB | 16.1 μL pyridine, | |
| | | | 190 μL 0.035549 M | |
| | | | mDNB | |
| 4 | 9:1 | 10% 0.25954 M | 234 μL BTEB, | 6 d |
| | BTEB:pyridine | DIOL | 16.1 μL pyridine, | |
| | | | 48.7 μL 0.25954 | |
| | | | M DIOL | |
| 5 | 9:1 | 1% 0.035549 M | 234 μL BTEB, | 1 hr |
| | BTEB:pyridine | mDNB | 16.1 μL pyridine, | |
| | | | 190 μL 0.035549 | |
| | | | M mDNB | |

The amount of mDNB and DIOL template varied depending on the concentration of the template solution. All sol-gels made in 50 mL THF with 81 μL H₂O and 75 μL TBAF catalyst. The sol-gels were then aged for one hr to 6 days at room temperature.

Solutions for film deposition onto integrated optical were prepared by mixing 50 mL tetrahydrofuran (THF), 520 μL BTEB, 912 μL mDNB in THF (0.0822 M), 162 μL water, and 150 μL tetrabutyl ammonium fluoride (TBAF). The solutions were aged for 6 days before deposition. Prior to deposition, the solutions were diluted by adding 5 mL of the sol-gel mixture to 50 mL of THF. The diluted solution was deposited as a film at a rate of 6 cm/min onto the center portion of the waveguides by coating the bottom portion of the substrate with removable optical tape. Following deposition, the films were annealed at 120° C. for 1 hr, Soxlet extracted for 1 hr with acetonitrile, and placed in a 5% v/v solution of cyanopropyldimethylchlorosilane in acetonitrile at room temperature for 24 hr. The films were rinsed again with acetonitrile for 1 hr and placed in ITMS for 5 min at 60° C. After removal from ITMS, the films were rinsed with methanol for 1 hr at 60° C. The films underwent a final acetonitrile rinse for 1 hr at room temperature prior to use as a sensing device.

The template was removed from the sensing layer using 0.5 M iodotrimethylsilane (ITMS) and acetonitrile at 60° C. for 30 min (FIG. 4 at step C). After 30 min, the waveguides were removed from the ITMS, briefly rinsed in acetonitrile and placed in methanol at 60° C. for 60 min. The slides were then placed either in fresh acetonitrile or rinsed in the soxhlet extractor with acetonitrile for 3 hrs. The treated waveguides were stored in jars of acetonitrile until tested.

### Example 5

### Construction of TNT Sensor System with Sensing Films

Prior to measurements, a waveguide sensor was removed from the acetonitrile and dried in a 60° C. oven for 2 min. The assembly was then mounted on a stage with a Schott optical glass prism (Karl Lambrecht, SF-6) placed on either end of the sensing film. The prisms were held in place using compression bars and hand tightened nuts. The waveguide was screwed onto a rotary stage (Pasco Scientific, SP-9416) and a xyz translational stage (Edmund Scientific, J33-484). The 530 nm line of Kr/Ar ion laser (Uniphase, 1136P) was focused onto the incoupling prism through a lens and iris. The placement of the beam was adjusted using the xyz translational stage. The light was incoupled into the waveguide through the first prism and was then totally internally reflected down the length of the waveguide. The second prism outcoupled the light, which was detected with a photodiode detector (Pasco, CI-6604). FIG. 2 shows a block diagram of the experimental set-up used to perform sensing tests on the waveguides.

With the waveguide mounted on the stage, a small funnel connected to the TNT generator was carefully positioned in front of the sensing film. A baseline outcoupled light intensity was measured. Once this was determined, vapor from the TNT chamber was blown onto the film. The flow of TNT was turned on and off three times for each trial. After the trial was completed, the wavelength of the laser was changed to 647 nm. The TNT flow was again turned on and off three times through the course of the experiment.

### Example 6

### Detection of TNT in Acetonitrile

After initial analyses, it was determined that the 1% mDNB template films (Films 1, 3, and 5) performed better than the 10% mDNB template film (Film 2). As a result, the 1% films were used for all subsequent experiments.

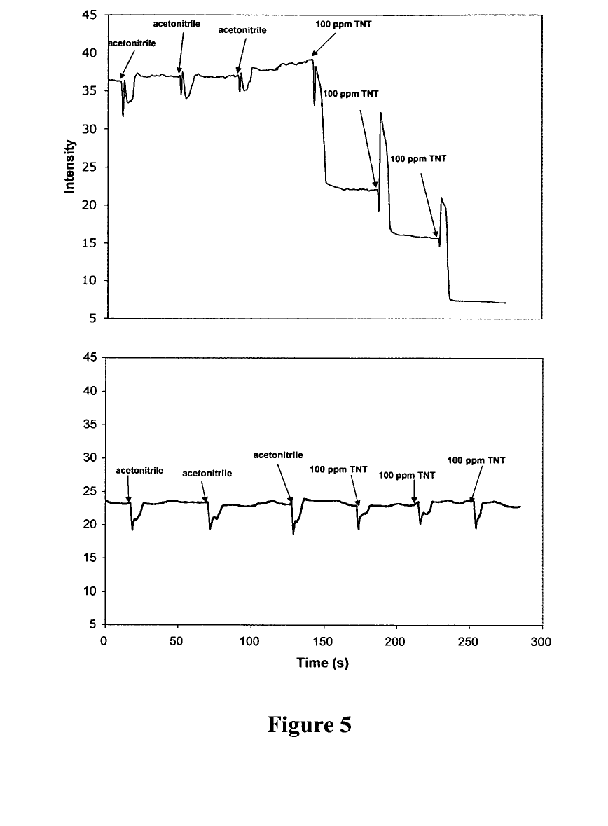

Film 1 and non-imprinted control (same sol-gel and processing steps, but lacking the template) deposited on integrated optical waveguides were tested with either an acetonitrile blank solution or 10 μL aliquots of 100 ppm TNT in acetonitrile. As the solution was passed across the sensing layer, a momentary spike in the intensity reading was observed. The imprinted sensing layer responded by a decrease in outcoupled light intensity, which eventually saturates. The results are illustrated in FIG. 5. The original outcoupled light intensity can be achieved, i.e., re-established, if the film is rinsed extensively with acetonitrile solvent.

This detection procedure has also been performed using a film imprinted using DIOL. The DIOL-imprinted film achieved similar results, although the mDNB imprinted films were more effective.

### Example 7

### Detection of TNT in Vapor Phase (Nitrogen)

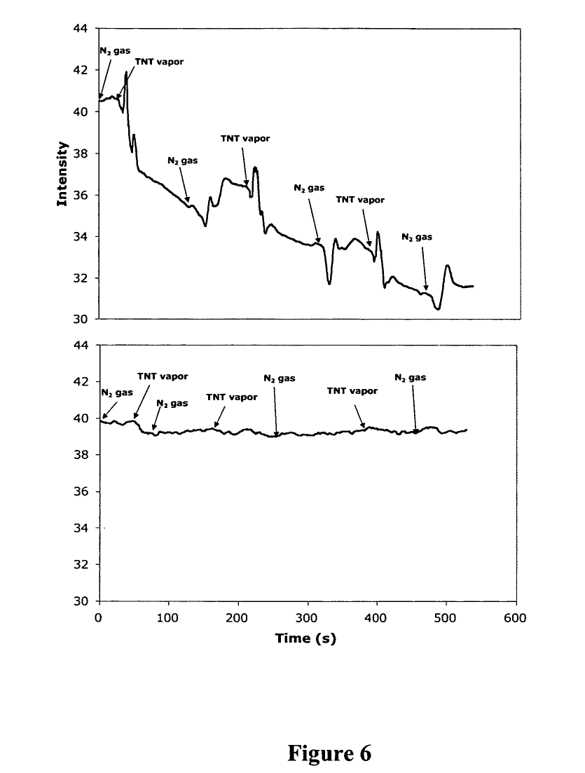

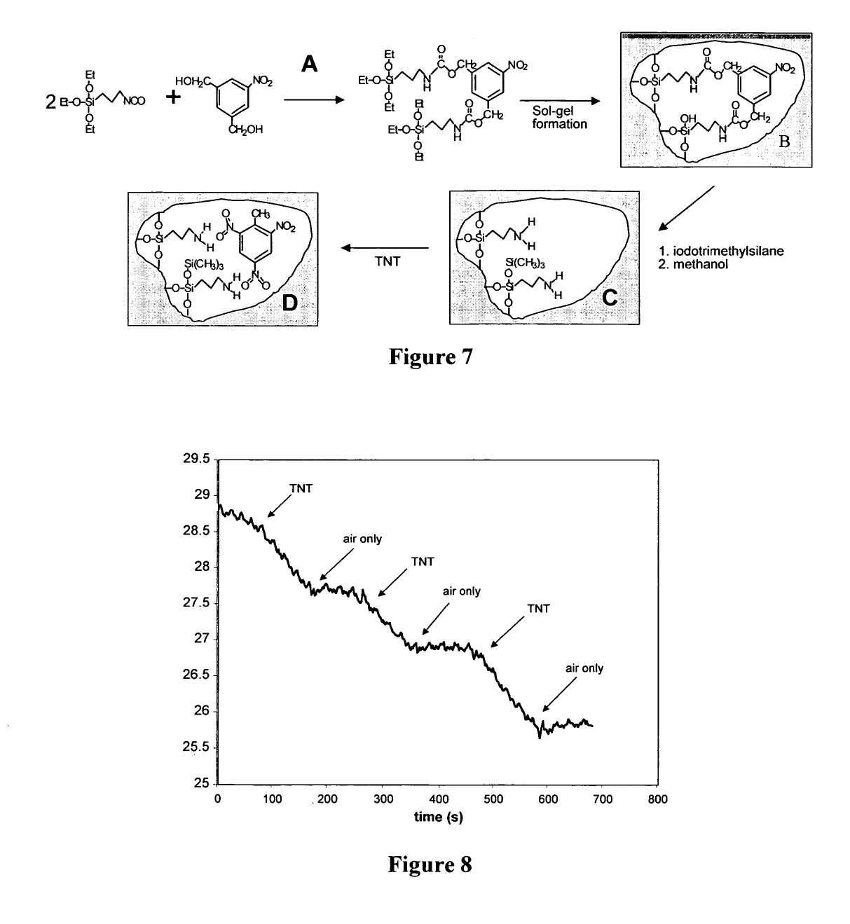

Film 1 and non-imprinted control deposited on integrated optical waveguides were tested for response to ˜10 femtomole/s TNT vapor in a 50 mL/min stream of nitrogen gas. The results are illustrated in FIG. 6. These tests demonstrate that the sensor according to this embodiment has a limit-of-detection for vapor phase TNT in the low parts-per-billion range (i.e., 1-10 ppb). (Because the test system employed required manual changing of the lines, a plug of air was introduced into the flow cell each time the gas stream was switched from pure nitrogen to nitrogen+TNT. This is responsible for the minor disruption observed in the spectra.)

The response to TNT in vapor phase is not reversible, which is expected since the formation of the TNT anion is thermodynamically favored and the anionic form of TNT is not easily flushed from the sol-gel (absent rinsing with acetonitrile as in Example 5).

This detection procedure has also been performed using a film imprinted using DIOL. The DIOL-imprinted film achieved similar results, although the mDNB imprinted films were more effective.

### Example 8

### Sensing Film Fabrication Using FPTES in Sol-Gel Matrix

An mDNB sol-gel was prepared using 50% BTEB and 50% FPTES as polymer-forming silanes. The following reagents were added sequentially: 50 mL THF, 65 μL BTEB, 55 μL FPTES, 287 μL of 0.130 M mDNB template, 40 μL H₂O 38 μL 1 M TBAF in THF. The solution was aged for 6 days at either room temperature or 60° C. After either monolith or film formation, the sol-gels were rinsed in acetonitrile and dried. Template was removed by heating the sol-gels (monoliths and films) at 250° C. for 4 hr in N₂. The material was then extensively rinsed with acetonitrile.

FPTES was chosen as a precursor for sensing film preparation because of results by other investigators indicating that TNT adsorbs quite well to Teflon films. Thus, a fluorinated matrix containing aromatic groups for pi-stacking interactions seemed to be ideal. Binding experiments from solution show that TNT is selectively taken up by the imprinted material. However, sensors constructed using these films have not shown response to TNT. One reason for this may be that the template was removed by thermally cleaving the carbamate linkage instead of chemical means using ITMS. During the past 8 months we have been investigating thermally removing the template on all of our formulations and none show good sensing results. Spectroscopic analysis of the films placed at high temperature indicate that there are significant changes in the sol-gel matrix, although AFM images of the same materials show the overall morphology of the films is unaffected. This may indicate that the binding pocket morphology is modified during the heat process.

### Example 9

### Solution Phase Binding Sensitivity of Imprinted Sol-Gel Films

Imprinted bulk sol-gel formed using mDNB in 9:1 BTEB:pyridine (i.e., used to make Film 3) was suspended in acetonitrile, and then separately exposed overnight to nitroaromatics (TNT, dinitrotoluene, and nitrotoluene) or toluene. Results were measured by HPLC. The binding sensitivity of the bulk-sol gel is shown in Table 2 below.

TABLE 2
Bulk Sol-gel Binding Data

| Test | | | |
|---|---|---|---|
| Molecule | Kᵢₘₚ | K_{con} | SR |
| TNT | 9.9 | 1.4 | 7.1 |
| DNT | 1.2 | 1.4 | 0.9 |
| 3NT | 0.2 | 0.12 | 1.7 |

| | |
|---|---|
| Toluene | No binding |

+/− are %5 relative error

In particular, the mDNB-imprinted BTEB:pyridine-silane sol-gel resulted in fairly good molecular imprinting results (Table 2). Interestingly, there is little or no binding of TNT to non-imprinted controls. Such a result is promising, because it indicates that the binding of the sensing film is selective. In general, the sol-gel response is quite similar to BTEB Film 1. Currently, TNT in air can be detected at a flux of less than 1 femtomole (10⁻¹⁵) per second. Selectivity appears good since there is no observed response to the structural analogue dinitrotoluene. Control experiments were performed by making sensor measurements using a wavelength of light that is not adsorbed by the TNT anion. No changes in outcoupled light intensity were measured unless the wavelength matched the absorbance spectrum of the TNT anion.

### Example 10

### Atomic Force and Scanning Electron Microscopy

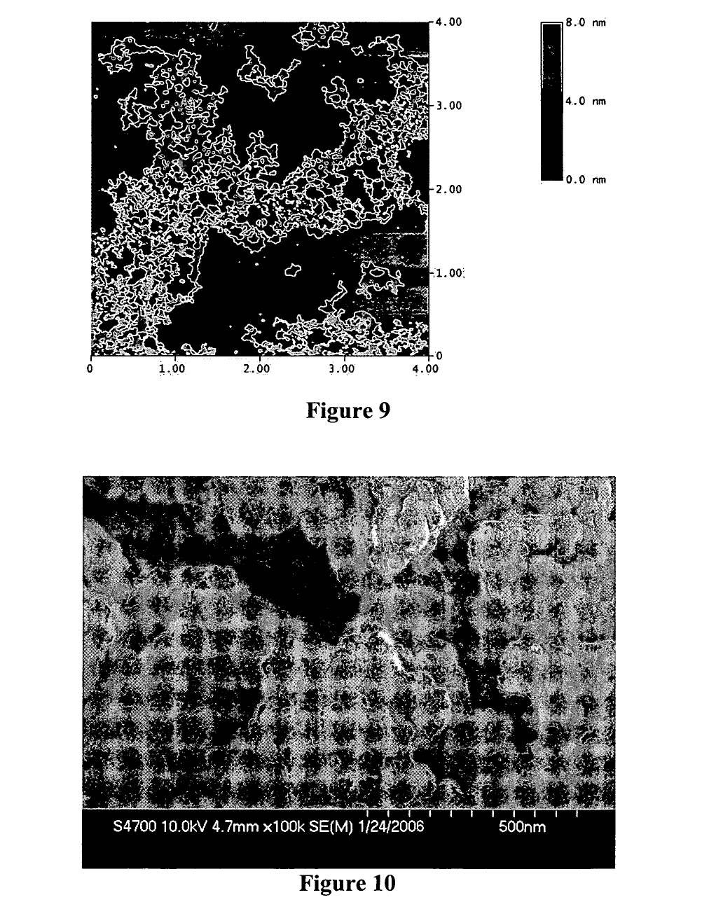

AFM and SEM have been used to study both films and monoliths, respectively. Interestingly, the sol-gels are comprised of 10-30 nm monodisperse nanoparticles (FIG. 9). In retrospect, this result was not surprising since there is some evidence for this reported in the literature. A subsequent set of experiments have been performed to determine the effect of various processing conditions on the microstructure. A material that possesses both meso- and micro-porosity seems is important. Meso for mass transfer; micro- for imprinting.

The TBAF catalyzed synthesis of sol-gel in THF (as described herein) leads to nanoparticle formation. Surface area and pore volume analysis of the materials combined with scanning electron microscopy (FIG. 10) have led to the conclusion that the particles themselves are not porous. If this is true, then only imprinted sites at or near the surface of the nanoparticles are available to bind TNT. The sol-gels were predominantly aged 6 days prior to deposition on the waveguides. As the sol-gel ages, nanoparticles interlink to form clusters. It remains to be determined exactly how this affects the binding of TNT at this time.

Discussion of Example 1-10

TNT anion formation when bound to the molecularly imprinted sol-gels demonstrates relativity slow kinetics for unknown reasons. Results (both visual and through sensor testing) indicate that it takes several minutes to several hours to get complete conversion of bound TNT to the anionic form. To help overcome these problems, sol-gel processing conditions are being optimized to generate a material that has smaller nanoparticle size (greater surface area to volume ratio). It is believed that lower concentrations of sol-gel precursors will yield smaller particles. To improve mass transport, the particles will be tethered to a more mesoporous acid catalyzed sol-gel matrix. Thus, future sol-gel will be prepared by combining nanoparticulate material generated by TBAF catalysis with an open sol-gel polymeric matrix formed by acid catalysis. Doping the sol-gel with a higher concentration of base to yield a more rapid deprotonation of TNT is also under investigation. The base can either be added by the inclusion of a functionalized sol-gel precursor added prior to polymerization, or an exogenous base doped into the matrix after the final synthesis and immediately prior to use as a sensor. Finally, other sol-gel precursors are being investigated, including those species that have positively charged functional group to promote anion formation.

### Example 11

### Preparation of mDNB-Imprinted Sol-Gel with Acetonitrile

A sol-gel for sensing film was prepared by co-polymerizing mDNB template alkoxysilane monomer with 9:1 BTEB:pyridine under the conditions recited for Film 3 in Table 1 above, except that the sol gel was made in 50 mL acetonitrile with 81 μL H₂O and 75 μL TBAF catalyst. The sol-gel was then aged for 6 days at room temperature.

### Example 12

### Limits of Detection Analysis in Air

Because TNT binding/anion formation is substantially irreversible (absent rinsing with acetonitrile as in Example 5), the sensor integrates the amount of TNT over time. It also makes the response to be irreversible, necessitating use of a new waveguide sensor once exposed to TNT. This adds to the ability to detect low concentrations of TNT. (Anecdotally, it was discovered that the sensors can saturate just by bringing them into the testing lab, which has trace amounts of TNT deposited on various lab equipment.)

A limit of detection analysis was performed using Films 1 and 3, as swell as a film prepared using the sol-gel of Example 11. The limit of detection was measured as the flux of TNT in air (in moles/s) to yield a 2.5% drop in light output during a 60 s exposure time. No noise reduction methods were used.

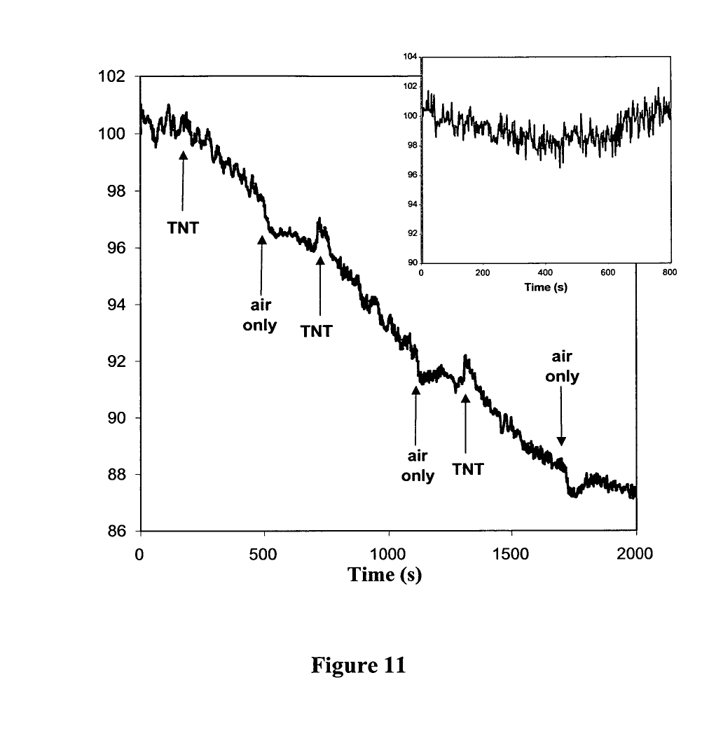

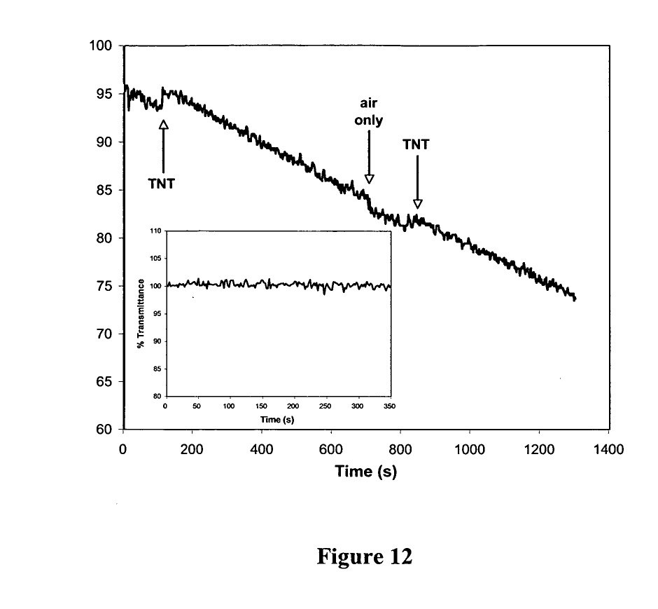

A simple control experiment was performed by switching the wavelength used to conduct the experiment from 530 nm to 647 nm; the latter wavelength is outside the absorbance band of TNT anion (FIGS. 11 and 12, insets). This makes for a simple way to self-correct the sensor for source drift while in use. The results of the limit of detection are shown in Table 3 below.

TABLE 3
Limits of Detection

| Sol-gel sensing layer | Solvent | LOD (moles/s) |
|---|---|---|
| 100% BTEB with 1% mDNB | THF | 7 × 10⁻¹³ |
| 90% BTEB/10% pyridine with 1% mDNB | THF | 2 × 10⁻¹³ |
| 90% BTEB/10% pyridine with 1% mDNB | acetonitrile | 3 × 10⁻¹⁴ |

The data presented in Table 3 show that use of acetonitrile as the solvent results in a gel capable of forming a sensor film that is more sensitive than the corresponding gel formed using THF (see also FIGS. 11 and 12). The choice in solvent resulted in nearly an order of magnitude difference in the limit of detection analysis for the 9:1 BTEB:pyridine mDNB films.

Experiments testing these materials to 2,4-dinitrotoluene, 3-nitrotoluene, and toluene were also performed. These gels showed little or no binding to these other materials. This confirmed the selectivity results of Example 9.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A chemically-sensitive film for use in a detector for TNT, said chemically sensitive film comprising a porous, polymeric structure and a plurality of basic functional groups integral with the porous, polymeric structure, the basic functional groups being selectively reactive with TNT.

2. The chemically-sensitive film according to claim 1, wherein the porous, polymeric structure comprises a siloxane backbone.

3. The chemically sensitive film according to claim 1, wherein the basic functional group is a primary or secondary amine, or an N-hetero ring.

4. The chemically sensitive film according to claim 1, wherein the film has a thickness of less than about 10 μm.

5. The chemically sensitive film according to claim 1, wherein the porous, polymeric structure further comprises a plurality of binding pockets, wherein one or more of the basic functional groups are present in each of the plurality of binding pockets.

6. A planar optical waveguide comprising a surface, and the film according to claim 1 applied to the surface of the planar optical waveguide.

7. A system comprising:
the planar optical waveguide according to claim 6;
a light source that couples light into the planar optical waveguide; and
a detector that senses emission of light from the planar optical waveguide, wherein the emitted light identifies presence of TNT.

8. The system according to claim 7 wherein the light source includes a light emitting device and either a prism or a gradient positioned to couple at least a portion of emitted light into the planar optical waveguide.

9. The system according to claim 7 wherein the light source emits substantially monochromatic light within 500-550 nm.

10. The system according to claim 7 wherein the light source emits a substantially collimated beam of light.

11. The system according to claim 7 wherein the light source is selected from the group consisting of a light-emitting diode, a laser, an incandescent or fluorescent light source, and diode laser.

12. The system according to claim 7 wherein the detector includes a light sensor and a prism or a gradient positioned to couple light from the planar optical waveguide to the light sensor.

13. The system according to claim 7 wherein the light sensor is a photodiode, charge-coupled display, spectrophotometer, or a phototransistor.

14. The system according to claim 7 further comprising a housing having a sample port in proximity to the film, whereby a sample introduced into the housing will pass over the film and allow any TNT in the sample to bind to the basic functional groups within the film.

15. The system according to claim 14 wherein the housing contains the planar optical waveguide, the light source, and the detector.

16. The system according to claim 7 further comprising a processor, a display, and a memory.

17. The system according to claim 7 wherein the system has a TNT detection limit of about 4×10⁻¹⁵ moles/s of TNT in air.

18. A method for detecting TNT in a sample comprising:
introducing a sample potentially containing TNT to the system according to claim 7, and
detecting a decrease in light outcoupled from the waveguide at a wavelength corresponding to TNT anion absorption, wherein the decrease in light outcoupled from the waveguide indicates presence of the TNT anion in the introduced sample.

19. The method according to claim 18, wherein the sample is in a condensed phase or gas phase.

20. The method according to claim 18, wherein the wavelength is between 500-550 nm.

21. The method according to claim 18 further comprising:
quantifying the amount of TNT detected based on the size of the decrease in light outcoupled from the waveguide at the wavelength.

22. A method of making the film according to claim 1 comprising:
forming a sol-gel solution in the presence of a first alkoxysilane compound having one or more sidechains that each contain a basic group reversibly bound to a moiety that is structurally similar to TNT; and
preparing from the sol-gel solution a porous, polymeric structure in the form of a film;
removing the moiety from the film, thereby forming the plurality of basic functional groups integral with the porous, polymeric structure.

23. The method according to claim 22 wherein the moiety is a nitroaromatic carbamyl or dicarbamyl.

24. The method according to claim 22 wherein said forming the sol-gel solution comprises a solvent in the presence of THF or acetonitrile.

25. The method according to claim 24 wherein said forming the sol-gel solution includes reacting the first alkoxysilane with a second alkoxysilane comprising an aromatic sidechain or bridging group.

26. The method according to claim 25 wherein said forming the sol-gel solution includes reacting the first alkoxysilane with a second alkoxysilane selected from the group of bis(2-(trimethoxysilyl)ethyl)benzene, 2-(2-(trimethoxysilyl)ethyl)pyridine, triethoxy(2,3,5,6-tetrafluoro-4-(trifluoromethyl)phenyl)silane, bis(trimethoxysilylpropyl)amine, bis(3-trimethoxysilylpropyl)-N-methylamine, 1,4-bistriethoxysilyl)benzene, p-bis(trimethoxysilylmethyl)benzene, bis(triethoxysilyl)ethane, bis(trimethoxysilyl)ethane, phenyltrimethoxysilane, methyltrimethoxysilane, isobutyltrimethoxysilane, N-(3-triethoxysilylpropyl)4,5-dihydroimidazole, 3-trifluoroacetoxypropyltrimethoxysilane, N-(3-trimethoxysilylpropyl)pyrrole, 3-(N,N-dimethylaminopropyl)trimethoxysilane, 3-(N,N-diethylaminopropyl)trimethoxysilane, 3-cyanopropyltrimethoxysilane, 2-cyanopropyltrimethoxysilane, and combinations thereof.

27. The method according to claim 26 wherein a combination of bis(2-(trimethoxysilyl)ethyl)benzene and 2-(2-(trimethoxysilyl)ethyl)pyridine is used in a molar ratio from about 3:2 up to about 20:1.

28. A trialkoxysilane compound according to formula (I) 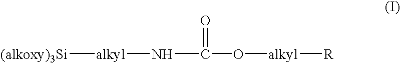
wherein each alkyl group is independently a C1 to C10 alkyl, each alkoxy group comprises a C1 to C4 alkyl, and R comprises a nitroaromatic ring.

29. The compound according to claim 28, wherein R is selected from the group consisting of nitrobenzyl, methylnitrobenzyl, methyldinitrobenzyl, methyltrinitrobenzyl, ethylnitrobenzyl, ethyldinitrobenzyl, ethyltrinitrobenzyl, dinitrobenzyl, trinitrobenzyl, nitrotoluenyl, dinitrotoluenyl, nitroxylyl, dinitroxylyl, trinitroxylyl, and nitrostyryl.

30. The compound according to claim 28, wherein the compound is 4-methyl-3,5-dinitrobenzyl 3-(trimethoxysilyl)propylcarbamate or 3,5-bis[3-(triethoxysilyl)propylcarbamyl]nitrobenzene.

31. The compound according to claim 28, wherein the compound has the structure according to formula (II)

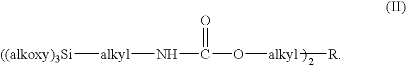

32. A sol-gel formed upon reaction of a (poly)alkoxysilane with the trialkoxysilane compound of claim 28.

33. The sol-gel according to claim 32 wherein the (poly)alkoxysilane comprises an aromatic bridging group or sidechain.

34. The sol-gel according to claim 32 wherein (poly)alkoxysilane is selected from the group of bis(2-(trimethoxysilyl)ethyl)benzene, 2-(2-(trimethoxysilyl)ethyl)pyridine, triethoxy(2,3,5,6-tetrafluoro-4-(trifluoromethyl)phenyl)silane, bis(trimethoxysilylpropyl)amine, bis(3-trimethoxysilylpropyl)-N-methylamine, 1,4-bistriethoxysilyl)benzene, p-bis(trimethoxysilylmethyl)benzene, bis(triethoxysilyl)ethane, bis(trimethoxysilyl)ethane, phenyltrimethoxysilane, methyltrimethoxysilane, isobutyltrimethoxysilane, N-(3-triethoxysilylpropyl)4,5-dihydroimidazole, 3-trifluoroacetoxypropyltrimethoxysilane, N-(3-trimethoxysilylpropyl)pyrrole, 3-(N,N-dimethylaminopropyl)trimethoxysilane, 3-(N,N-diethylaminopropyl)trimethoxysilane, 3-cyanopropyltrimethoxysilane, 2-cyanopropyltrimethoxysilane, and combinations thereof.
